(19) United States
(12) Patent Application Publication
(10) Pub. No.: US 2016/0168980 A1
(43) Pub. Date: Jun. 16, 2016

(54) DUAL-ENDED DISTRIBUTED TEMPERATURE SENSOR WITH TEMPERATURE SENSOR ARRAY

(71) Applicants: Mark BEDRY, Houston, TX (US); Ronald JOHNSON, Woodward, OK (US); Andre R. Vincelette, Quebec (CA)

(72) Inventors: Mark BEDRY, Houston, TX (US); Ronald JOHNSON, Woodward, OK (US); Andre R. Vincelette, Quebec (CA)

(21) Appl. No.: 14/970,151

(22) Filed: Dec. 15, 2015

Related U.S. Application Data
(60) Provisional application No. 62/092,090, filed on Dec. 15, 2014.

(51) Int. Cl. E21B 47/06; G01K 11/32

(52) U.S. Cl. CPC E21B 47/065; G01K 11/3206

(57) ABSTRACT

Methods and apparatus are provided for distributed temperature sensing along an optical waveguide disposed axially with respect to a conduit using a distributed temperature sensor and an array of temperature sensors. An exemplary method includes performing distributed temperature sensing (DTS) using two ends of a first optical fiber disposed within the conduit and having a return path coupling the two ends, performing discrete temperature sensing based on measured reflections of light from reflective elements having characteristic wavelengths disposed at discrete locations, and determining temperatures at a plurality of locations based on the DTS and the discrete temperature sensing.

### CROSS-REFERENCE TO RELATED APPLICATIONS

The present Application for Patent claims priority to U.S. Provisional Application No. 62/092,090, filed Dec. 15, 2014, which is assigned to the assignee of the present application and hereby expressly incorporated by reference herein in its entirety.

### BACKGROUND

1. Field of the Disclosure

Embodiments of the present disclosure generally relate to downhole sensing and, more particularly, to performing distributed temperature sensing.

2. Description of the Related Art

The world's reservoirs are aging. This translates to increased water production and gas coning, increased lifting costs, expensive treatment of produced water, and high cost of deferred or lost hydrocarbon production. Hence, it is becoming increasingly important to accurately measure and understand conditions inside a well, reservoir, or field. Downhole sensing offers measurement near the areas of interest—e.g., near the wellbore or reservoir—and thus offers potential for higher quality data, more insight across a sandface, and measurement of parameters that are not available on the surface. This information can be used to optimize production, locate water or gas coning, manage fractures or fluid movement in the reservoir from events or disturbances, etc.

In the hydrocarbon industry, there is considerable value associated with the ability to monitor the temperature of the downhole environment of a well in real time. Temperature measurements may be important in producing from, injecting into, or storing fluids in downhole subsurface reservoirs. Further, fluid properties, such as viscosity, chemical elements, and the content of oil, water, and/or gas, may also be important measurements.

Steam assisted gravity drainage (SAGD) well operators need to log temperatures in their observation and horizontal injection and producing wells periodically for reasons of production optimization, regulatory requirements, and various other reasons. Historically, temperature has been sensed with distributed temperature sensor (DTS) devices directly disposed downhole within the well. A DTS consists of an optical fiber that is interrogated using a sophisticated surface-based optical-electronic instrument. The interrogation is based on measurement of the naturally occurring reflections that are scattered back all along the optical waveguide (e.g., Raman backscatter) from optical pulses introduced into the fiber by the surface-based optical-electronic instrument. The sensing device senses the changes in the scattered light propagating through the optical waveguide. The changes in the scattered light may be due to changes in the temperature of the environment surrounding the waveguide, which may change the index of refraction of the optical waveguide or mechanically deform the waveguide such that the optical propagation time or distance, respectively, changes (e.g., the Raman scattered signal changes). Due to the thermal characteristics of typical DTS systems, a separate downhole temperature measurement point must be made to calibrate the DTS data.

Separate downhole temperature measurements for calibrating DTS systems may be made by thermocouples and flasked memory gauges that are placed alongside the DTS system. Thermocouples are not highly precise, with typical margins of error of plus or minus three degrees Celsius. Flasked memory gauges are more accurate, but can only be used for 4-8 hours in high temperature environments. There are also environmental contamination risks associated with utilizing lithium batteries, which power the flasked memory gauges, in high temperature environments.

Other devices used for making separate downhole temperature measurements for calibrating DTS systems in wells have included an array of thermocouples on a cable. These prior art sensor arrays may consist of multiple discrete devices, and the deployment of an array of sensors may be complex, time-consuming and expensive. For example, when performing temperature sensing in a wellbore, the array may have to be moved to different areas of the wellbore to gain coverage of the desired physical locations to be sensed.

Distributed sensing systems have various effective measurement spatial resolutions along the optical waveguide depending on the selected pulse widths and optical power of the light source. By analyzing reflections and measuring the time between the optical signal being launched and the signal being received, a distributed sensing instrument may be able to measure the effect of temperature changes on the optical signal at all points along the optical waveguide, limited only by the spatial resolution. Useful instantaneous, relative changes, time lapse, or accumulated data may be derived from the measured signals.

However, distributed sensing, which is typically accomplished using one or two optical fibers, is hindered by limited resolution and sensitivity to optical losses and back reflections. The optical losses and back reflections can be caused by connectors and cable terminations, which can affect signal-to-noise ratio (SNR), stability, and dynamic range.

There is therefore a need for techniques and apparatus to perform downhole and other measurements over relatively long distances without the measurement impediments noted above.

### SUMMARY

Embodiments of the present disclosure generally relate to sensing a downhole temperature by performing distributed sensing using a continuous optical fiber with instruments at each end, calibrated by means of an optical fiber with reflective elements. Examples of suitable reflective elements include fiber Bragg gratings (FBGs), which may be written directly into the optical fiber.

One embodiment of the present disclosure is a method for determining temperatures associated with a conduit. The method generally includes performing distributed temperature sensing (DTS) using two ends of a first optical fiber disposed within the conduit and having a return path coupling the two ends, performing discrete temperature sensing based on measured reflections of light from reflective elements having characteristic wavelengths disposed at discrete locations, and determining temperatures at a plurality of locations based on the DTS and the discrete temperature sensing.

Another embodiment of the present disclosure is a system for determining temperatures associated with a conduit. The system generally includes a first optical fiber disposed within the conduit comprising two ends and having a return path coupling the two ends, reflective elements having characteristic wavelengths disposed at discrete locations, and at least one processor configured to perform distributed temperature sensing (DTS) using the two ends of the first optical fiber, perform discrete temperature sensing based on measured reflections of light from the reflective elements, and determine temperatures at a plurality of locations based on the DTS and the discrete temperature sensing.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates an example wellbore having a casing and production tubing with an optical fiber for distributed temperature sensing, according to certain embodiments of the present disclosure.

FIG. 2 illustrates an example wellbore having a casing and production tubing with an optical fiber for distributed temperature sensing, according to certain embodiments of the present disclosure.

FIG. 3 illustrates an example wellbore having a casing and production tubing with an optical fiber for distributed temperature sensing disposed within coiled tubing, according to certain embodiments of the present disclosure.

FIG. 4A illustrates an example optical fiber with reflective elements spliced into the optical fiber, according to certain embodiments of the present disclosure.

FIG. 4B illustrates an example optical fiber with reflective elements written directly into the optical fiber, according to certain embodiments of the present disclosure.

FIG. 5 illustrates an example system for performing distributed temperature sensing, according to certain aspects of the present disclosure.

FIG. 6 shows a schematic diagram of an exemplary system including one single-ended optical fiber that is used for DTS with reflective elements that are used for ATS, according to an embodiment of the present disclosure.

FIG. 7 shows a schematic diagram of an exemplary system including two single-ended optical fibers, with one optical fiber used for DTS and a second optical fiber used for ATS, according to an embodiment of the present disclosure.

FIG. 8 shows a schematic diagram of an exemplary system including a single-ended optical fiber and a double-ended optical fiber, according to an embodiment of the present disclosure.

FIG. 9 shows a schematic diagram of an exemplary system including one double-ended optical fiber that is used for DTS with reflective elements that are used for ATS, according to an embodiment of the present disclosure.

FIG. 10 shows a schematic diagram of an exemplary system including a double-ended optical fiber with reflective on both sides of the U-bend, according to an embodiment of the present disclosure.

FIG. 11 illustrates example operations for performing distributed temperature sensing, according to an embodiment of the present disclosure.

FIG. 12 illustrates example operations for determining temperature associated with a conduit by performing distributed temperature sensing, according to an embodiment of the present disclosure.

### DETAILED DESCRIPTION

Aspects of the present disclosure provide techniques that may help improve performance of systems utilizing distributed temperature sensing (DTS). For example, the techniques may allow calibration of a DTS fiber, single or double-ended, to discrete temperature measurements of an array of reflective elements (e.g., fiber Bragg gratings (FBGs)). In a second example, the techniques may allow calibration of a DTS fiber, single or double-ended, based on discrete optical power loss measurements of an array of reflective elements (e.g., fiber Bragg gratings (FBGs)).

As described above, multi-point electronic and optical sensors and distributed optical sensors have been developed and installed in wells to measure various downhole parameters. Discrete transducer devices offer reliable measurements, but can be cumbersome to deploy. Distributed sensing such as distributed temperature sensing (DTS) is typically accomplished using only a fiber or multiple fibers in a cable, thereby simplifying deployment. However, these measurements are hampered by sensitivity to optical losses and back reflections caused by connectors, cable terminations, etc. Signal-to-noise ratio (SNR), stability, and dynamic range are affected, and the value of the distributed measurements can therefore be limited.

Accordingly, what are needed are techniques and apparatus to perform these and other measurements over relatively long distances (e.g., tens of meters to many kilometers) without these measurement impediments.

Embodiments of the present disclosure provide techniques and apparatus for distributed temperature sensing along an optical fiber by measuring backscatter reflections from the optical fiber and measuring reflections from reflective elements (e.g., FBGs) corresponding to discrete locations at points of interest. Taking measurements at an array of discrete locations may be referred to as array sensing. Utilizing distributed temperature sensing and array sensing in this manner may allow collection of measurements all along a wellbore without moving the sensing device, thereby reducing the time for performing such sensing, which, in turn, decreases the cost, and may also allow for more precise temperature measurements at sensed locations.

### Example Downhole Distributed Temperature Sensing System

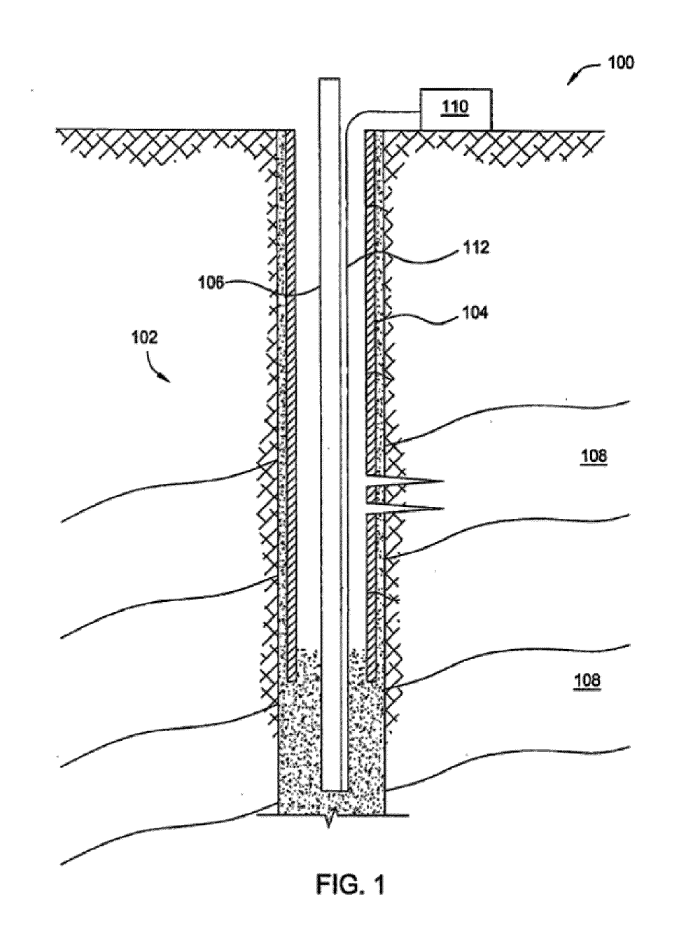

FIG. 1 illustrates a schematic cross-sectional view of a downhole completion and distributed temperature sensing system 100. The system 100 generally includes a wellbore 102, casing 104, production tubing 106, sensing device 110, and optical waveguide 112. At least a portion of the system 100 may be disposed adjacent one or more reservoirs 108 downhole.

The wellbore 102 may have casing 104 disposed within, through which production tubing 106 may be deployed as part of a wellbore completion. The sensing device 110 may be used to perform temperature measurement related to the wellbore 102. Properties of the wellbore 102, a wellbore completion (e.g., casing, cement, production tubing, packers), and/or downhole formations and interstitial fluid properties surrounding or otherwise adjacent the wellbore 102 may be monitored over time based on the temperature measurements. Further, hydrocarbon production may be controlled, or reservoirs 108 may be managed, based on the temperature measurements.

The temperature sensing system 100 may perform sensing along the optical waveguide 112. An optical waveguide 112, such as an optical fiber, within the wellbore 102 may function as the actual sensing unit. The sensing system 100 may employ a single fiber or multiple fibers in the same well and/or multiple wells. For example, multiple fibers may be utilized in different sections of a well, so that sensing may be performed in the different sections. Sensing may determine relative temperatures at relative levels or stations, temperatures at a set of immediately adjacent depth levels, or temperatures at a set of spatially remote depths.

The sensing system 100 may include a sensing device 110 to introduce light (e.g., an optical pulse), using a pulsed laser, for example, into an end of the optical waveguide 112. The sensing device 110 may measure backscattered reflections from all along the waveguide. The sensing device 110 may include not only an optical source, but one or more processing units for performing signal processing and analysis. In this manner, the sensing system 100 may be used to determine temperatures related to reflections in the optical waveguide 112.

The technique of determining temperatures related to reflections in an optical waveguide is based on measurement of Raman, Brillouin, and Rayleigh backscatter. A distributed temperature sensor (DTS) instrument sends a short laser pulse into an optical fiber and measures photons scattered back from within the fiber. The DTS instrument measures a time of flight of the laser pulse and the photons scattered back from within the fiber. From the measured time of flight of a photon scattered back, the position of element in the fiber that scattered the photon back can be calculated. Most backscattered photons have the same frequency as the original laser pulse. Some photons, however, will show the effect of Raman, Brillouin, and Rayleigh scattering, with some photons having a lower frequency (called Stokes) than the original laser pulse and others a higher frequency (called anti-Stokes) than the original laser pulse. The intensity of the anti-Stokes backscatter is very sensitive to the temperature of the scattering element, while the intensity of the Stokes backscatter is much less sensitive. The ratio of the anti-Stokes backscatter to the Stokes backscatter may be used to calculate a temperature of the fiber at the location of the scattering element.

### Example Dual-Ended Distributed Temperature Sensor With Temperature Sensor Array

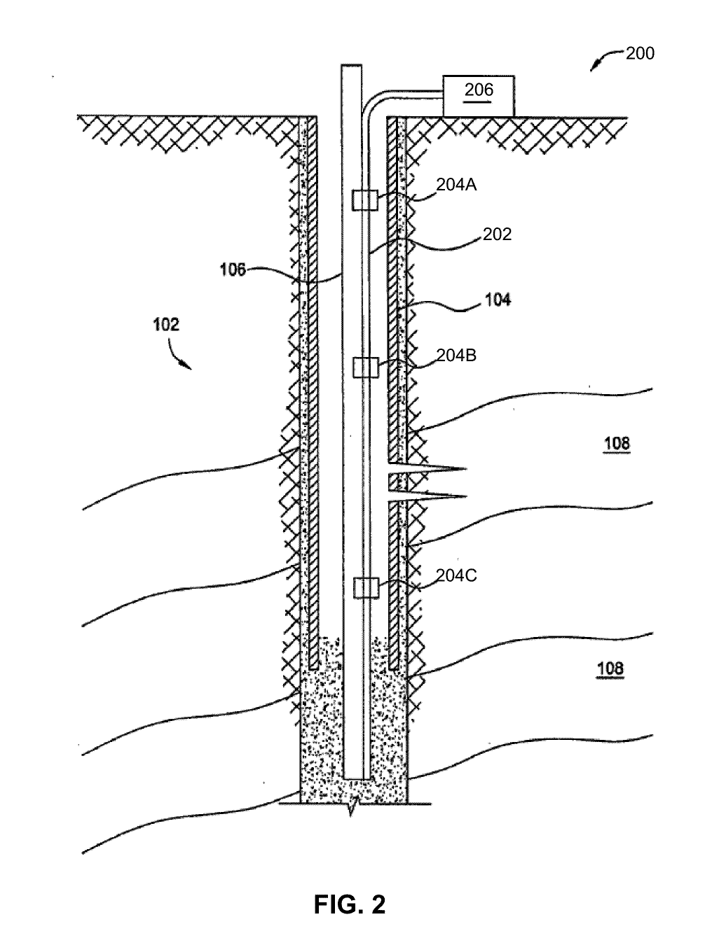

As illustrated in FIG. 2, in some embodiments, a distributed temperature sensing system 200 employs an optical waveguide 202 having reflective elements disposed at one or more discrete sensing locations 204 (e.g., 204A, 204B, 204C). As will be described in greater detail below, measurements of the DTS system 200 may be calibrated based on measurements taken at the discrete sensing locations 204.

In some cases, the optical waveguide may be disposed with both ends connected to a sensing device 206. As shown in FIG. 2, the optical waveguide 202 may be a continuous optical fiber which runs along (i.e., is axially disposed with respect to) at least a portion of the length of production tubing 106, casing 104, or other conduit.

The sensing device 206 may introduce light (e.g., an optical pulse), using a pulsed laser, for example, into an end of the optical waveguide 202. The sensing device 206 may measure backscattered reflections from all along the waveguide. The sensing device 206 may introduce light and measure backscattered reflections from each end of the optical waveguide 202. The sensing device 206 may include not only an optical source, but one or more processing units for performing signal processing and analysis. In this manner, the distributed temperature sensing system 200 may be used to determine temperatures related to reflections in the optical waveguide 202.

The discrete sensing locations 204 may be located on the optical waveguide 202 with a pre-determined spacing or to correspond to selected areas of interest when the optical waveguide is deployed in a wellbore. For some embodiments, the discrete sensing locations may be spaced apart. For example, each discrete sensing location may be hundreds of meters from a next sensing location.

The reflective elements at the discrete sensing locations 204 may have the same characteristic wavelength, λ. For some embodiments, adjacent reflective elements may each have different characteristic wavelengths, such that adjacent reflective elements may be interrogated using wavelength division multiplexing (WDM). In other words, light pulses of different wavelengths or a broadband pulse (i.e., a light pulse covering a wide spectrum of wavelengths) may be introduced in an optical waveguide simultaneously, and, when reflective elements having different characteristic wavelengths are present in the optical waveguide, the location of a measurement can be identified based on wavelengths of reflections from the reflective elements, thus allowing multiplexing of measurements. The reflective elements may be FBGs, for example.

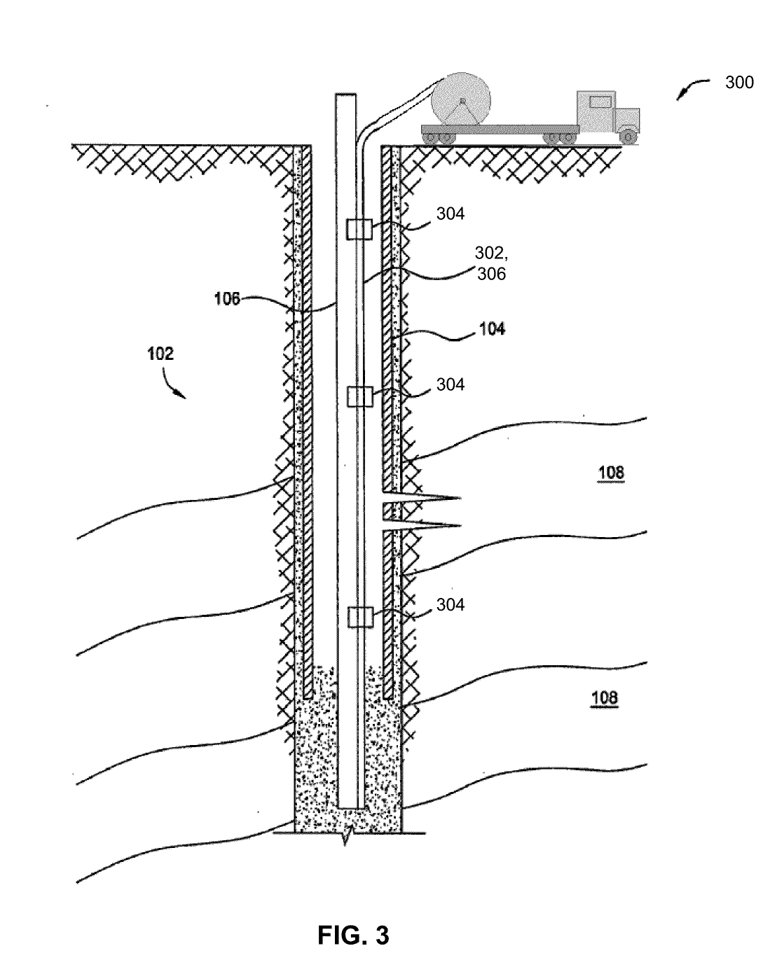

As illustrated in FIG. 3, according to certain embodiments, a distributed temperature sensing system 300 may comprise coiled tubing 306. The exemplary distributed temperature sensing system 300 may be similar to the exemplary distributed temperature sensing system 200 (see FIG. 2) and may comprise discrete sensing locations 304 that are similar to discrete sensing locations 204 (see FIG. 2). An optical waveguide 302 may be disposed within the coiled tubing 306. The optical waveguide 302 may be similar to the optical waveguide 202 shown in FIG. 2.

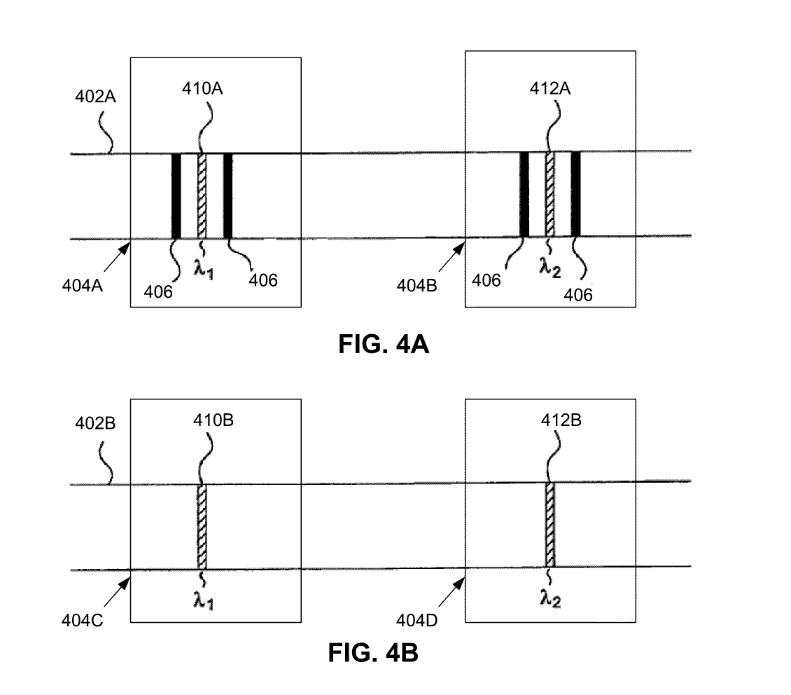

As illustrated in FIGS. 4A and 4B, FBGs may be spliced into an optical waveguide 402A or inscribed directly into a continuous optical waveguide 402B. Optical waveguides 402A, 402B may be similar to optical waveguides 202 (see FIGS. 2) and 302 (see FIG. 3). FIG. 4A shows the optical waveguide 402A with FBGs 410A, 412A spliced into the optical waveguide 402A at splices 406. Writing FBGs 410B, 410B directly into the optical waveguide 402B without splicing allows for a continuous fiber, as shown in FIG. 4B, thereby eliminating defects introduced by splicing. Such defects may affect (e.g., by reflecting some light) light propagation within the optical waveguide.

Distributed temperature measurement (i.e., distributed temperature sensing (DTS)) may be performed all along the lengths of the optical waveguides 202 (see FIG. 2), 302 (see FIG. 3), 402A and 402B. Array temperature measurement (i.e., array temperature sensing (ATS)) may also be performed using reflective elements (e.g., FBGs 410, 412) at each of discrete measurement locations 404A, 404B, 404C, 404D. The discrete measurement locations may be similar to the discrete measurement locations 204 (see FIGS. 2) and 304 (see FIG. 3). The array temperature measurement may be performed by introducing light into the optical waveguide and measuring reflections from reflective elements at each of the discrete measurement locations. The characteristic wavelength of the reflective elements varies with the temperature of the optical fiber, allowing determination of the temperature at each discrete measurement location, based on the reflections from the reflective elements.

The results of the array temperature measurement may be used to calibrate the distributed temperature sensing system, as discussed above and further described below. The distributed temperature sensing system may determine temperature all along the optical waveguide, based on the array temperature measurements of the discrete locations and the measured backscatter reflections from the optical waveguide.

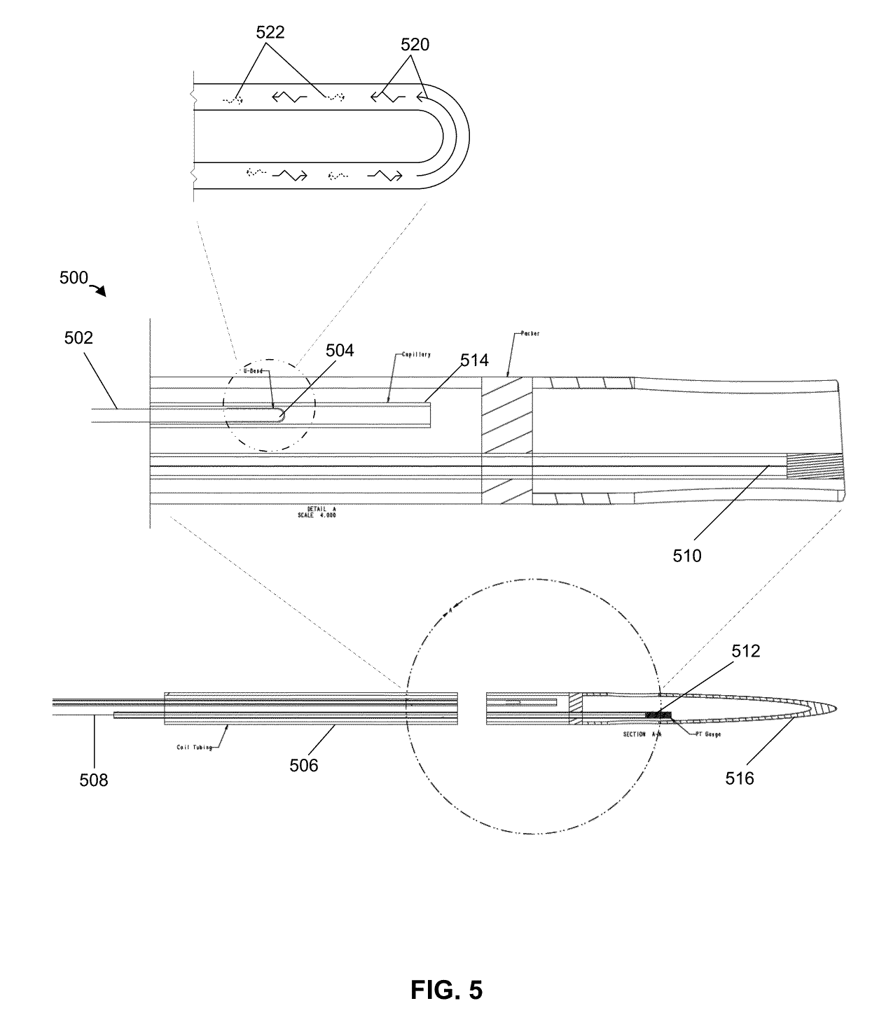

FIG. 5 illustrates an example system 500 for performing distributed temperature sensing, according to certain aspects of the present disclosure. The exemplary system may be part of the distributed temperature sensing system 200 shown in FIG. 2. A first optical fiber is shown at 502. The first optical fiber may comprise a U-bend 504, and two ends (not shown in FIG. 5) that may be connected to a sensing device (also not shown in FIG. 5). The arrows 520 represent a path through the optical fiber traversed by one or more light pulses, while the dashed arrows 522 represent paths through the optical fiber traversed by reflections (e.g., backscattering or reflections from reflective elements). While shown with a U-bend, the U-bend is not necessary to all aspects of the present disclosure, and if the U-bend is not present, then only one end of the first optical fiber is connected to a sensing device, with the other end of the first optical fiber disposed within the wellbore. The first optical fiber may be within a capillary 514 enclosed within coil tubing 506 with a bull nose 516 in order to facilitate placing the U-bend within a conduit or wellbore, although other embodiments are also included within the scope of the disclosure. A second optical fiber is shown at 508, with one end 510 within the coil tubing 506 and the other end (not shown in FIG. 5) connected to a sensing device (also not shown in FIG. 5), e.g., sensing device 206 shown in FIG. 2. The second optical fiber may comprise a pressure sensor 512, although this is not necessary to all aspects of the present disclosure.

The first optical fiber may include the reflective elements shown in FIGS. 4A and 4B used for array temperature sensing. The reflective elements may be present in the first optical fiber on only one side of the U-bend or on both sides of the U-bend. Alternatively or additionally, the second optical fiber may include the reflective elements shown in FIGS. 4A and 4B. A sensing device (e.g., sensing device 206 shown in FIG. 2) may determine temperatures at various discrete locations based on reflections from the reflective elements in the first or second optical fibers.

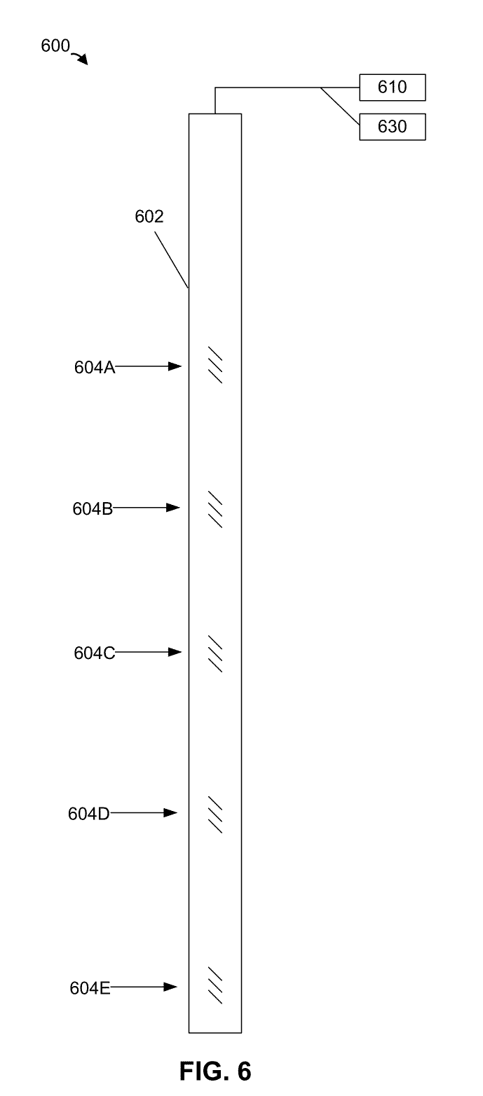

In other words, in one embodiment of the present disclosure, the example system 500 for performing distributed temperature sensing may include one single-ended optical fiber used for DTS with reflective elements used for array temperature sensing (ATS). That is, both DTS and ATS may be performed in one single-ended optical fiber. FIG. 6 shows a schematic diagram of an exemplary system 600 including one single-ended optical fiber 602 that is used for DTS with reflective elements 604 that are used for ATS. The block 610 represents a sensing device operable to perform ATS using the optical fiber 602 and the various reflective elements 604, and the block 630 represents a sensing device operable to perform DTS using the optical fiber 602. While the exemplary system is illustrated with five reflective elements, the disclosure is not so limited and from two to 100 reflective elements may be used. The measurements determined by the DTS may be adjusted based on measurements determined by the ATS, as described in more detail below.

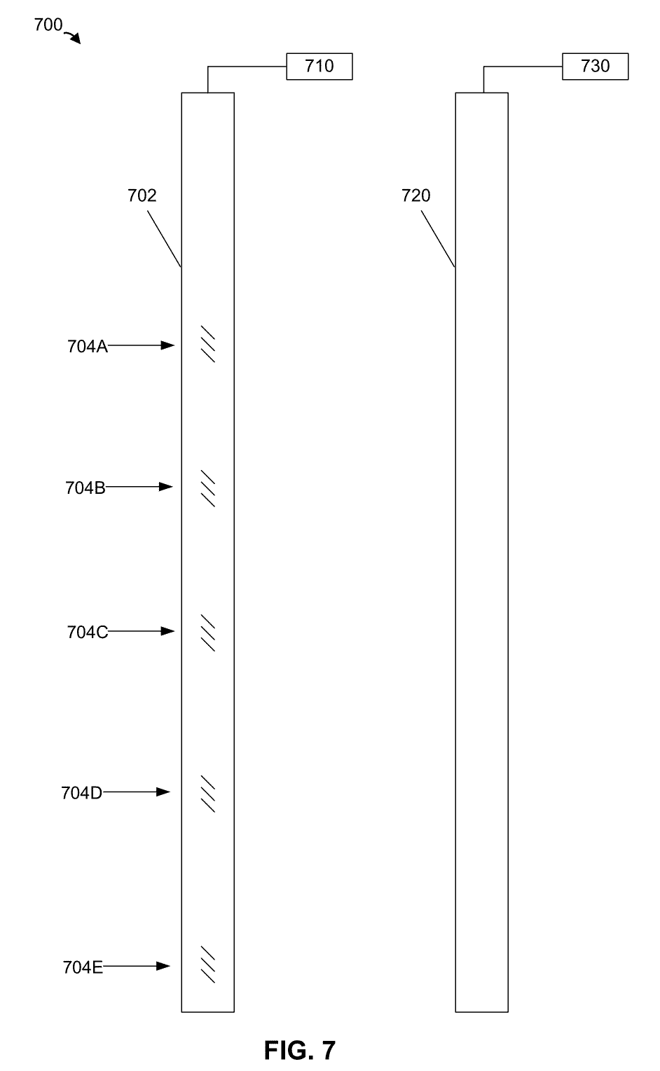

In a second embodiment of the present disclosure, the example system 500 for performing distributed temperature sensing may include two single-ended optical fibers, with one optical fiber used for DTS and one optical fiber with reflective elements used for ATS. FIG. 7 shows a schematic diagram of an exemplary system 700 including two single-ended optical fibers 702 and 720, with optical fiber 720 used for DTS and optical fiber 702 used for ATS. The block 710 represents a sensing device operable to perform ATS using the optical fiber 702 and the various reflective elements 704. While the exemplary system is illustrated with five reflective elements, the disclosure is not so limited and from two to 100 reflective elements may be used. The block 730 represents a sensing device operable to perform DTS using the optical fiber 720.

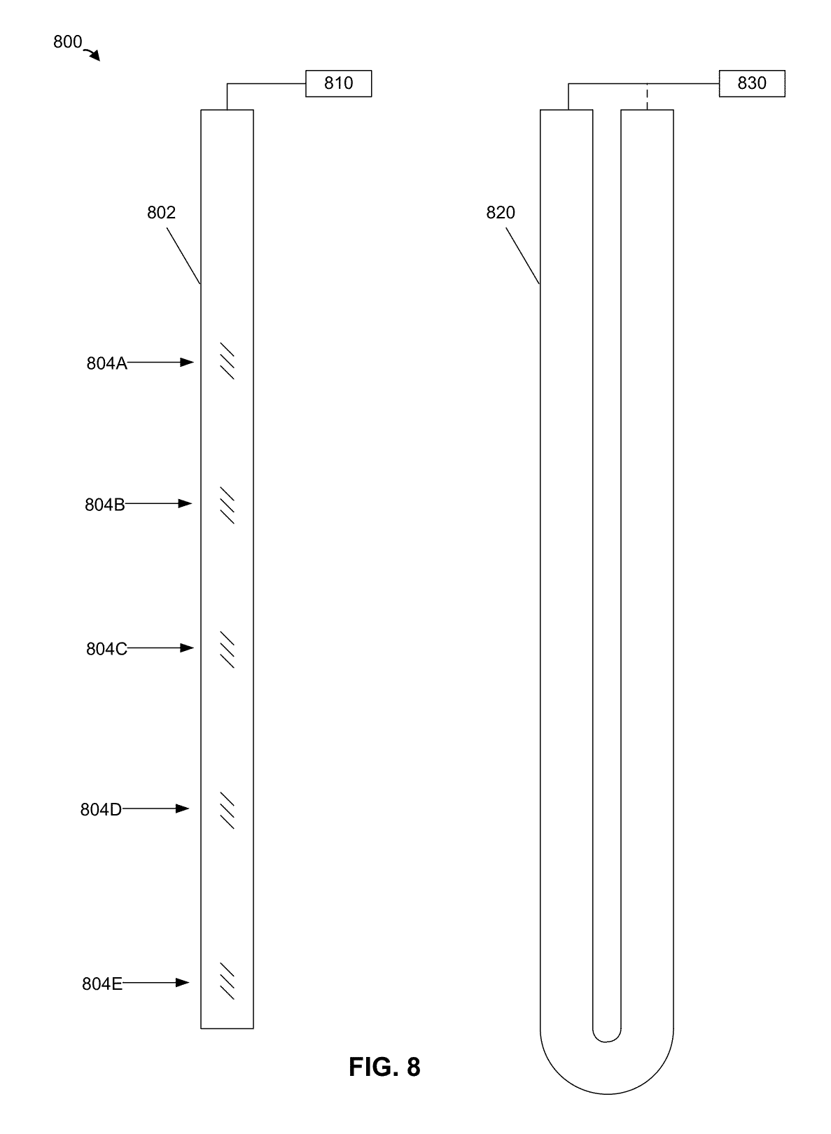

In a third embodiment of the present disclosure, the example system 500 may include one double-ended (e.g., with a U-bend) optical fiber used for DTS and a single-ended optical fiber with reflective elements used for ATS. FIG. 8 shows a schematic diagram of an exemplary system 800 including a single-ended optical fiber 802 and a double-ended optical fiber 820. The block 810 represents a sensing device operable to perform ATS using the optical fiber 802 and the various reflective elements 804. As with other exemplary systems, the exemplary system is illustrated with five reflective elements, but the disclosure is not so limited, and from two to 100 reflective elements may be used. The block 830 represents a sensing device operable to perform DTS using the optical fiber 820. As previously mentioned, the sensing device 830 may measure backscattered reflections from both legs of the double-ended optical fiber 820 and use the measurements of the reflections for performing DTS.

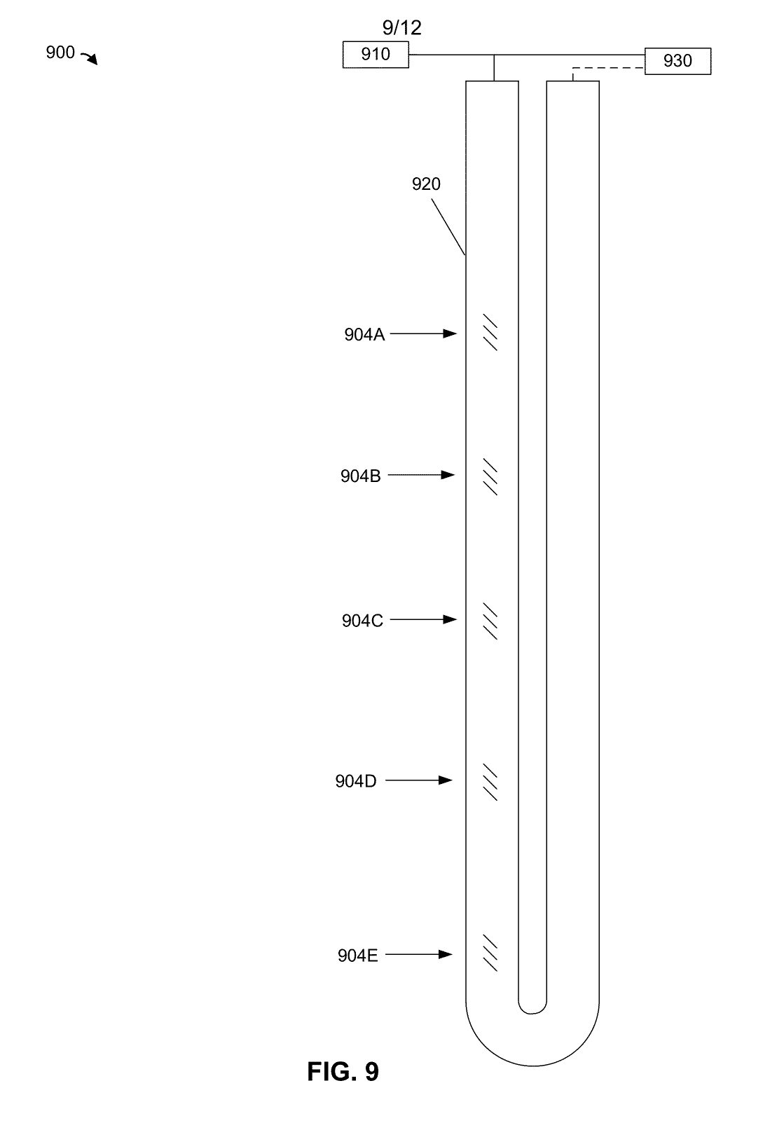

In a fourth embodiment of the present disclosure, the example system 500 may include one double-ended optical fiber used for double-ended DTS with reflective elements used for ATS on one side of the U-bend of the double-ended optical fiber. That is, both double-ended DTS and ATS may be performed using the same double-ended optical fiber, which has reflective elements on one leg. FIG. 9 shows a schematic diagram of an exemplary system 900 including one double-ended optical fiber 920 that is used for DTS with reflective elements 904 that are used for ATS. The block 910 represents a sensing device operable to perform ATS using the optical fiber 920 and the various reflective elements 904, and the block 930 represents a sensing device operable to perform DTS using the optical fiber 902. While the exemplary system is illustrated with five reflective elements, the disclosure is not so limited and from two to 100 reflective elements may be used. As with exemplary system 800, the sensing device 930 may measure backscattered reflections from one leg or from both legs of the double-ended optical fiber 920 and use the measurements for performing DTS.

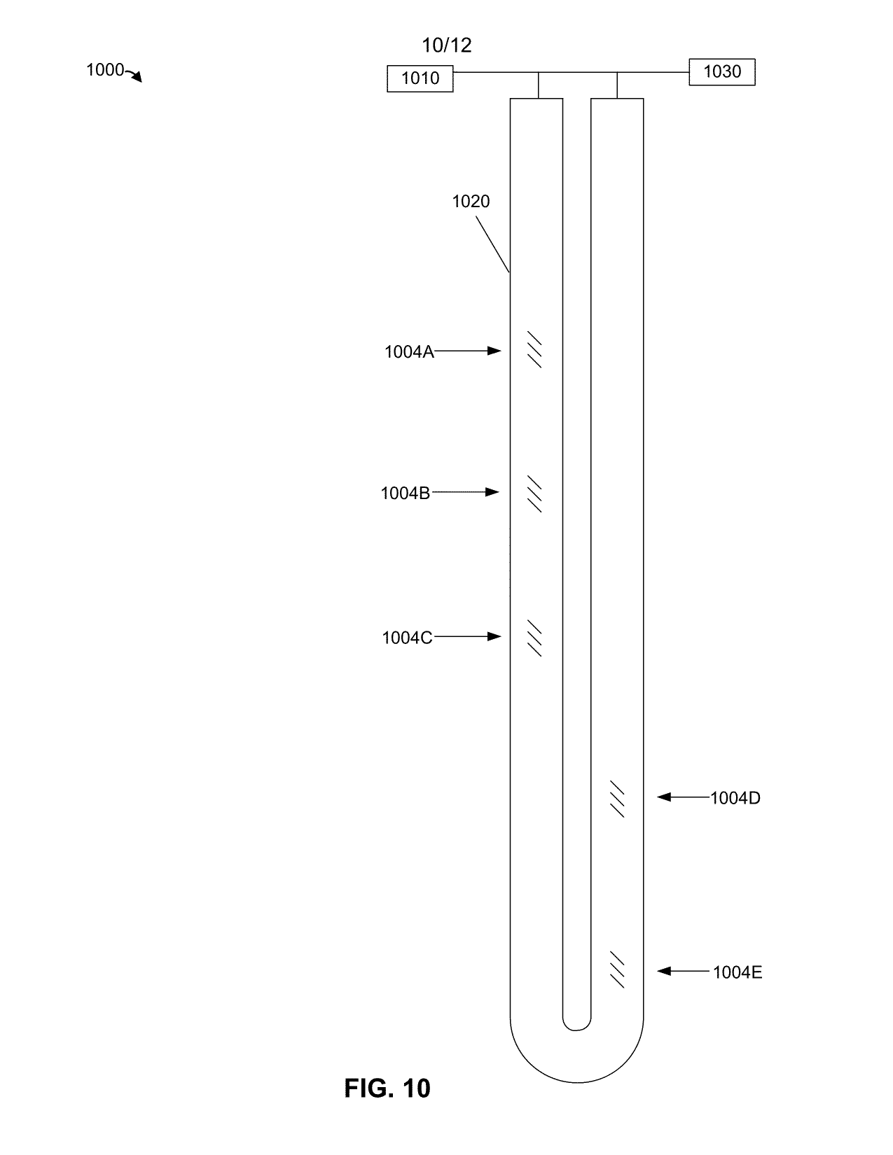

In a fifth embodiment of the present disclosure, the example system 500 may include one double-ended optical fiber used for double-ended DTS with reflective elements used for ATS on both sides of the U-bend (e.g., on both legs) of the double-ended optical fiber. FIG. 10 shows a schematic diagram of an exemplary system 1000 including a double-ended optical fiber 1020 with reflective on both sides of the U-bend. The block 1010 represents a sensing device operable to perform ATS using the optical fiber 1020 and the various reflective elements 1004. As with other exemplary systems, the exemplary system is illustrated with five reflective elements, but the disclosure is not so limited, and from two to 100 reflective elements may be used. The block 1030 represents a sensing device operable to perform DTS using the optical fiber 1020.

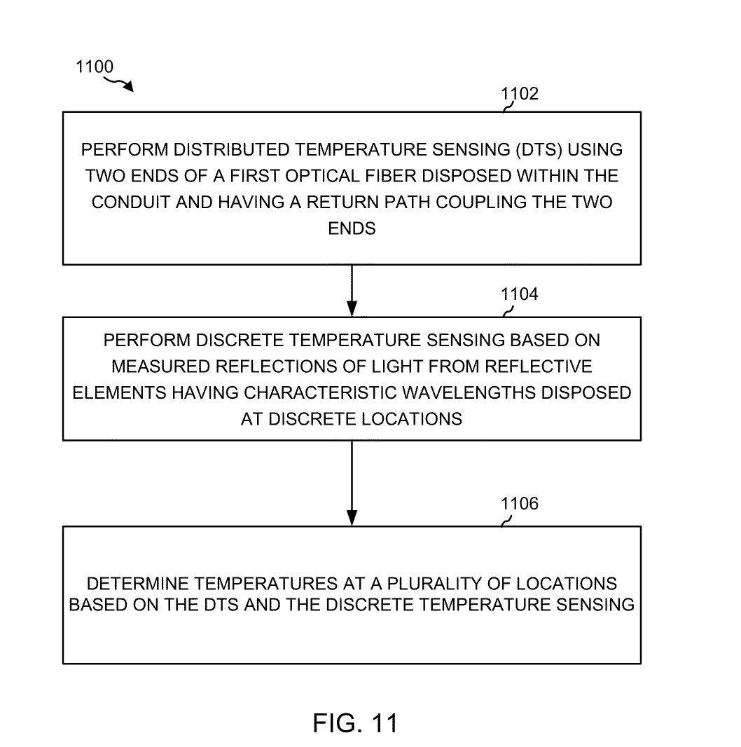

FIG. 11 illustrates example operations 1100 for determining temperature associated with a conduit by performing distributed temperature sensing, according to embodiments of the present disclosure. The operations may begin at block 1102 by performing distributed temperature sensing (DTS) using two ends of a first optical fiber (e.g., optical fiber 1020 shown in FIG. 10) disposed within the conduit and having a return path coupling the two ends. At block 1104, the operations may continue by performing discrete temperature sensing based on measured reflections of light from reflective elements (e.g., reflective elements 1004 shown in FIG. 10) having characteristic wavelengths disposed at discrete locations. At block 1106, the operations may continue by determining temperatures at a plurality of locations based on the DTS and the discrete temperature sensing.

According to some embodiments, the step of determining temperatures at a plurality of locations may comprise calibrating the DTS based on the discrete temperature sensing. The calibration may be performed based on any suitable calibration techniques, using measurements taken at discrete locations (e.g., points along an FBG array).

For example, calibrating the DTS may comprise measuring the temperature using distributed temperature sensing at one or more discrete locations along the first optical fiber; measuring the temperature at one or more discrete locations along the first optical fiber using reflections from at least one of the reflective elements, determining the differences ΔTᵢ between the temperature measured by the DTS at the respective locations and the temperature measured along the first optical fiber at the respective locations of the reflective elements, and using ΔTᵢ to adjust temperatures measured using the DTS, wherein i is an index corresponding to the reflective elements. For locations other than the discrete locations, temperatures measured using the DTS may be adjusted using an average, weighted average, or other function of one or more ΔTᵢ. That is, a temperature at a location other than a location of a reflective element may be determined by adjusting a temperature measured using the DTS at the location and adjusting the DTS-measured temperature by a function of one or more ΔTᵢ. The function may comprise selecting the ΔTᵢ of a nearest discrete location with a reflective element or averaging the ΔTᵢ of two nearest discrete locations with reflective elements. Alternatively, the function may comprise determining a weighted average of the ΔTᵢ of two or more nearest discrete locations, wherein the average is weighted according to the distances of the two or more nearest discrete locations.

According to some embodiments of the present disclosure, the operations may further comprise determining a pressure within the conduit. The pressure may be determined at discrete locations within the conduit, possibly including at the end of the second optical fiber. The pressure may be determined based on measured reflections (e.g., reflections from the end of the second optical fiber).

According to some embodiments of the present disclosure, each reflective element has a different characteristic wavelength than each other reflective element. In such cases, the reflective elements with the different characteristic wavelengths are optionally used at block 1104 to multiplex reflections of the light therefrom in an effort to identify at least one of the discrete locations.

### Example Dual-Ended Distributed Temperature Sensor With Optical Power Loss Sensor

According to some embodiments of the present disclosure, a distributed temperature sensing system (e.g., DTS system 200 shown in FIG. 2) employing an optical waveguide having reflective elements disposed at one or more discrete sensing locations (e.g., locations 204A, 204B, 204C shown in FIG. 2) may be calibrated based on optical power loss measurements taken on reflections of light from the discrete sensing locations.

Distributed temperature measurement (i.e., distributed temperature sensing (DTS)) may be performed all along the lengths of the optical waveguides 202 (see FIGS. 2) and 302 (see FIG. 3). Optical power loss sensing may also be performed using reflective elements at each of discrete measurement locations 204A, 204B, 204C, 304A, 304B, and 304C. The optical power loss sensing may be performed by introducing light into the optical waveguide and measuring reflections from reflective elements at each of the discrete measurement locations. The optical power loss measurements may be used to correct Stokes to Anti-Stokes ratios measured with a DTS system, allowing determination of the temperature at each discrete measurement location, based on the reflections from the reflective elements and DTS measurements from the discrete measurement locations.

The determined temperatures of the discrete measurement locations may be used to calibrate the distributed temperature sensing system. The distributed temperature sensing system may determine temperature all along the optical waveguide, based on the optical power loss measurements of the discrete locations and the measured backscatter reflections from the optical waveguide.

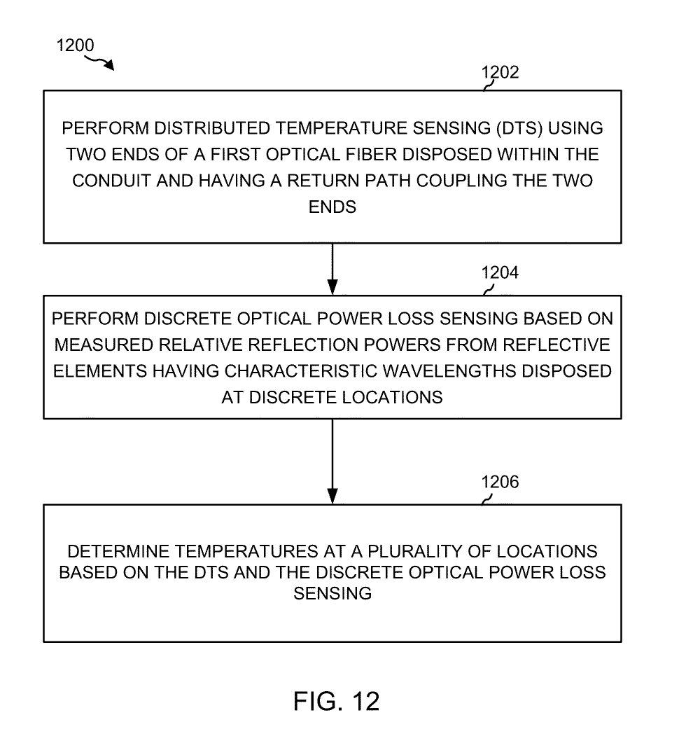

FIG. 12 illustrates example operations 1200 for determining temperature associated with a conduit by performing distributed temperature sensing, according to embodiments of the present disclosure. The operations may begin at block 1202 by performing distributed temperature sensing (DTS) using two ends of a first optical fiber (e.g., optical fiber 1020 shown in FIG. 10) disposed within the conduit and having a return path coupling the two ends. At block 1204, the operations may continue by performing discrete optical power loss sensing based on measured relative reflection powers from reflective elements (e.g., reflective elements 1004 shown in FIG. 10) having characteristic wavelengths disposed at discrete locations. At block 1206, the operations may continue by determining temperatures at a plurality of locations based on the DTS and the discrete optical power loss sensing.

According to some embodiments, the step of determining temperatures at a plurality of locations may comprise calibrating the DTS based on the discrete optical power loss sensing. The calibration may be performed based on any suitable calibration techniques, using optical power loss measurements taken at discrete locations (i.e., points having reflective elements, such as reflective elements 604, 704, 804, 904, and 1004 in FIGS. 6-10).

For example, calibrating the DTS may comprise measuring the temperature using distributed temperature sensing at one or more discrete locations along the first optical fiber; measuring optical power loss of reflections from reflective elements at one or more discrete locations along the first optical fiber, correcting the Stokes to Anti-Stokes ratios at the discrete locations based on the determined optical power loss measurements, determining corrected temperatures at the discrete locations based on the corrected ratios, determining differences ΔTᵢ between the uncorrected temperature measured by the DTS at each respective location and the corrected temperature at each respective location, and using ΔTᵢ to adjust temperatures measured using the DTS, wherein i is an index corresponding to the reflective elements. For locations other than the discrete locations, temperatures measured using the DTS may be adjusted using an average, weighted average, or other function of one or more ΔTᵢ. That is, a temperature at a location other than a location of a reflective element may be determined by adjusting a temperature measured using the DTS at the location and adjusting the DTS-measured temperature by a function of one or more ΔTᵢ. The function may comprise selecting the ΔTᵢ of a nearest discrete location with a reflective element or averaging the ΔTᵢ of two nearest discrete locations with reflective elements. Alternatively, the function may comprise determining a weighted average of the ΔTᵢ of two or more nearest discrete locations, wherein the average is weighted according to the distances of the two or more nearest discrete locations.

According to some embodiments of the present disclosure, the operations may further comprise determining a pressure within the conduit. The pressure may be determined at discrete locations within the conduit, possibly including at the end of the second optical fiber. The pressure may be determined based on measured reflections (e.g., reflections from the end of the second optical fiber).

According to some embodiments of the present disclosure, each reflective element has a different characteristic wavelength than each other reflective element. In such cases, the reflective elements with the different characteristic wavelengths are optionally used at block 1204 to multiplex reflections of the light therefrom in an effort to identify at least one of the discrete locations.

It is understood that the specific order or hierarchy of steps in the processes disclosed above is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

Moreover, the term “or” is intended to mean an inclusive “or” rather than an exclusive “or.” That is, unless specified otherwise or clear from the context, the phrase, for example, “X employs A or B” is intended to mean any of the natural inclusive permutations. That is, for example the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. A phrase referring to “at least one of” a list of items refers to any combination of those items, including single members. As an example, at least one of: a, b, or c″ is intended to cover: a, b, c, a-b, a-c, b-c, and a-b-c.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

While the foregoing is directed to embodiments of the present disclosure, other and further embodiments of the disclosure may be devised without departing from the basic scope thereof, and the scope thereof is determined by the claims that follow.

1. An apparatus for determining temperatures associated with a conduit, comprising:
an optical fiber having two legs coupled by a U-bend, a first end and a second end, wherein a first distance from the first end to the second end is smaller than a second distance from the first end to the U-bend.

2. A system for determining temperatures associated with a conduit, comprising:
a first optical fiber disposed within the conduit comprising two ends and having a return path coupling the two ends;
reflective elements having characteristic wavelengths disposed at discrete locations; and
at least one processor configured to:
perform distributed temperature sensing (DTS) using the two ends of the first optical fiber,
perform discrete temperature sensing based on measured reflections of light from the reflective elements, and
determine temperatures at a plurality of locations based on the DTS and the discrete temperature sensing.

3. The system of claim 2, wherein the at least one processor is further configured to calibrate the DTS based on the discrete temperature sensing.

4. The system of claim 2, wherein the first optical fiber is disposed within coiled tubing.

5. The system of claim 2, wherein the return path comprises a U-bend.

6. The system of claim 2, further comprising:
a second optical fiber, wherein the reflective elements are formed in at least the second optical fiber.

7. The system of claim 6, wherein the at least one processor is further configured to determine a pressure at an end of the second optical fiber within the conduit.

8. The system of claim 7, wherein the pressure is determined based on measured reflections from the second optical fiber.

9. The system of claim 2, wherein:
adjacent reflective elements have different characteristic wavelengths, and
the at least one processor is further configured to interrogate adjacent reflective elements using wavelength division multiplexing (WDM).

10. The system of claim 2, wherein the reflective elements comprise fiber Bragg gratings (FBGs).

11. The system of claim 2, wherein the first optical fiber comprises a continuous optical fiber with no splices between the first optical fiber and the reflective elements.

12. A system for determining temperatures associated with a conduit, comprising:
a first optical fiber disposed within the conduit comprising two ends and having a return path coupling the two ends;
reflective elements having characteristic wavelengths disposed at discrete locations; and
at least one processor configured to:
perform distributed temperature sensing (DTS) using the two ends of the first optical fiber,
perform discrete optical power loss sensing based on measured reflections of light from the reflective elements, and
determine temperatures at a plurality of locations based on the DTS and the discrete optical power loss sensing.

13. The system of claim 12, wherein the at least one processor is further configured to calibrate the DTS based on the discrete optical power loss sensing.

14. The system of claim 12, wherein the first optical fiber is disposed within coiled tubing.

15. The system of claim 12, wherein the return path comprises a U-bend.

16. The system of claim 12, further comprising:
a second optical fiber, wherein the reflective elements are formed in at least the second optical fiber.

17. The system of claim 16, wherein the at least one processor is further configured to determine a pressure at an end of the second optical fiber within the conduit.

18. The system of claim 12, wherein:
adjacent reflective elements have different characteristic wavelengths, and
the at least one processor is further configured to interrogate adjacent reflective elements using wavelength division multiplexing (WDM).

19. The system of claim 12, wherein the reflective elements comprise fiber Bragg gratings (FBGs).

20. The system of claim 12, wherein the first optical fiber comprises a continuous optical fiber with no splices between the first optical fiber and the reflective elements.
